(19) United States
(12) Patent Application Publication
(10) Pub. No.: US 2004/0231485 A1
(43) Pub. Date: Nov. 25, 2004

(54) Tile cutting machine

(75) Inventor: Joachim Eckstein, Fulda (DE)

Correspondence Address: CROWELL & MORING LLP, INTELLECTUAL PROPERTY GROUP, P.O. BOX 14300, WASHINGTON, DC, 20044-4300, US

(73) Assignee: Fliesen Eckstein GmbH & Co. KG, Fulda-Bernhards (DE)

(21) Appl. No.: 10/738,137

(22) Filed: Dec. 18, 2003

(30) Foreign Application Priority Data
Dec. 20, 2002 (DE) 102 59 867.3

(51) Int. Cl. B28D 1/32; B28D 5/04; B26F 3/00

(52) U.S. Cl. 83/886; 225/96.5; 125/23.02

(57) ABSTRACT

A tile cutting machine comprising a supporting plate (1) for a tile to be cut, comprising a tool guide (2), running over the supporting plate (1), for a cutting tool and comprising a swivel head (9), which can be moved by defined angular amounts, has on the swivel head (9) a ruler (4) with a straight guide. Into the latter one of two laterally reversed try squares (5, 6) can be inserted selectively from the right or left side.

The invention relates to a tile cutting machine comprising a supporting plate for a tile to be cut, a tool guide running over the supporting plate for a cutting tool and a swivel head, which can be moved by defined angular amounts about a swivel head axis and which holds a try square, which is provided with a measuring scale and which can be slid lockingly in a straight guide of the swivel head with a guide bar and which exhibits a contact bar, which extends at right angles to the guide bar and for which additionally the swivel head exhibits a ruler with a contact edge, which runs through the swivel axis.

A tile cutting machine of the above class is the subject of the DE 87 15 018.2 U1. In the prior art tile cutting machine both legs of the try square form one contact edge each for the tile to be cut. One leg of the try square is guided in a straight guide of the swivel head so that it can be clamped and said leg exhibits a measuring scale so that one can read the distance between the other contact edge and the swivel axis. The drawback with the prior art tile cutting machine is that the try square forms with one leg a contact edge and with its other leg projects automatically always towards the same side of the supporting plate. When one must cut the tiles at an angle or diagonally so that they are adapted, for example, to the contour of a right hand or left hand tilt angle, then the try square has to be adjusted when changing from the left to the right tilt angle, and the requisite dimension can no longer be read directly on the measuring scale of the try square, but rather a difference has to be calculated and said difference has to be set with the try square, a procedure that runs, of course, the risk of an error. It would be simpler for right and left walls or tilt angles to put the tiles to be cut on the tile cutting machine, as a function of the wall side, with the front side or the rear side up, a feature that is almost impossible, because normally it is possible to cut tiles, only by scoring their front side with a cutting tool.

The invention is based on the problem of designing the tile cutting machine in such a manner that for all possible angular or diagonal cuts the requisite dimension can be read directly on the measuring scale of the try square.

This problem is solved, according to the invention, by a total of two laterally reversed try squares for insertion into the straight guide starting from the side opposite the swivel head axis.

This design makes it possible to install selectively the one or the other try square into the tile cutting machine for right or left walls or tilt angles. Thus, the dimension, measured with a rule, between the last laid tile and the edge, up to which the tile to be laid is supposed to reach, can be set directly on the try square, so that there is no need to convert dimensions. Similarly the desired angle of an angular cut can be easily set.

The range, over which the try square can be moved, can be chosen especially large, if, according to an improvement of the invention, the ruler projects beyond the swivel head in the direction of the sides, oriented in opposite directions, forms a first contact edge and exhibits a continuous straight guide, into which the guide bar of the respective try square can be installed.

Even lengths that can no longer be read on the ruler, can be set without tedious computing and without having to resort to the additional aid of a separate rule, if both sides of the swivel head axis exhibit a ruler with a measuring scale that begins with zero, starting from the swivel axis; and the guide bar exhibits a measuring scale that begins with zero when its respective contact edge is above the swivel head axis.

Common angular dimensions, such as 45°, 60° or 120°, can be set on the swivel head without having to pay attention to whether the lines on a scale line up when, according to another improvement of the invention, the swivel head forms a semi-circular segment and exhibits indexing notches on a fixed pitch circle with uniform angular spacing and when the supporting plate exhibits a spring-loaded ball detent for dropping a ball into the individual indexing notches. Owing to this design, the swivel head drops releaseably into the most useful angular positions.

The swivel head can be locked into position in an especially simple way, if on the outside along the periphery of the swivel head a curved member, provided with an angle scale, is recessed, so as not to rotate, into the supporting plate. Said curved member exhibits a graduation in the direction of the swivel head, when the swivel head has correspondingly a graduation, oriented in the direction of the curved member, and when a clamping bolt's head, aligning with the upper side of the swivel head and the curved member, sits on the two graduations. Said clamping bolt, penetrating the supporting plate, is designed so as to move into a clamping position by means of a clamping device.

One advantageous design is embodied in an embodiment, according to which the clamping bolt has a head on the rear side of the supporting plate; and the clamping device exhibits a clamping fork, which is to be slid into its clamping position between the head of the clamping bolt and the supporting plate by means of an adjusting lever.

The invention permits various embodiments. For further illustration of its basic principle, one embodiment is depicted in the drawings and is described below.

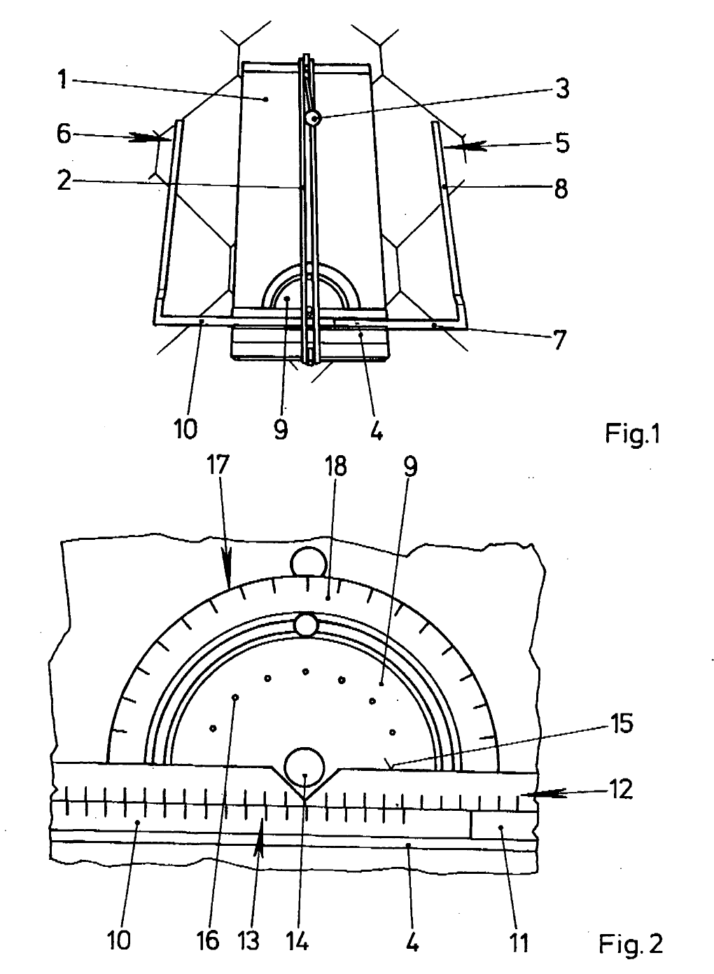

FIG. 1 is a perspective top view of a tile cutting machine, according to the invention.

FIG. 2 is a top view of the area of a swivel head of the tile cutting machine.

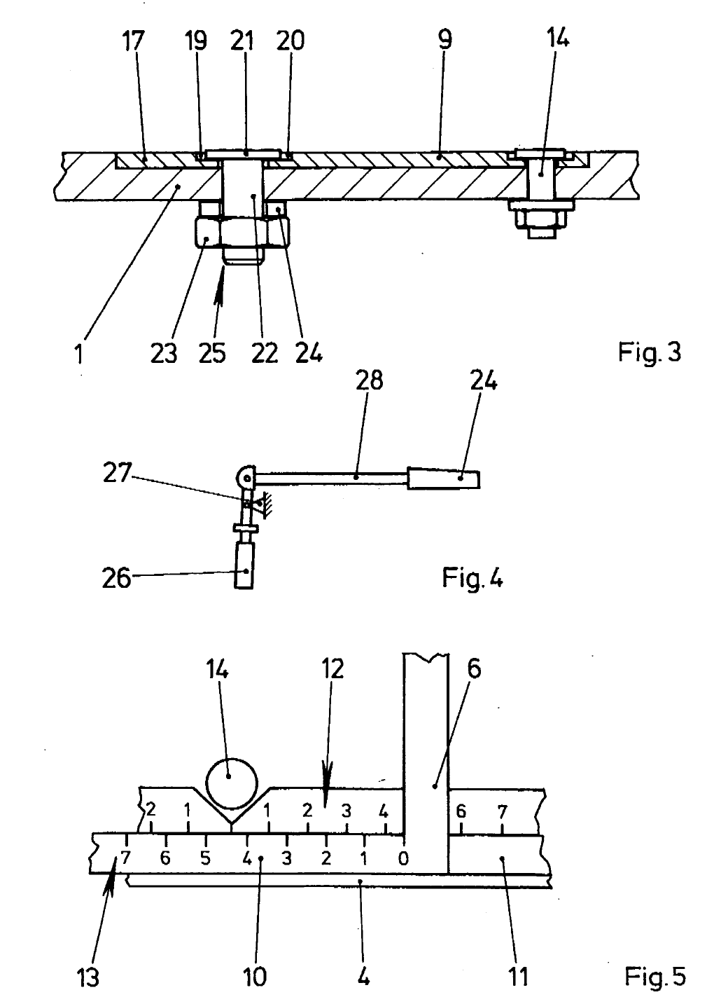

FIG. 3 is a sectional view of a sub-area of a supporting plate of the tile cutting machine.

FIG. 4 depicts a sub-area of a clamping device.

FIG. 5 is a sub-area of a ruler and a try square of the tile cutting machine.

FIG. 1 depicts a wood supporting plate 1, over which stretches a tool guide 2, along which is to move by means of a hand lever 3 a cutting tool (not illustrated) in the form of a wheel to be rolled over the tile to be cut. To position the tile to be cut there is a ruler 4 and two try squares 5, 6, where, depending on the side of the wall for which the tiles are to be cut, the one try square 5 or the other try square 6 is used.

The two try squares 5, 6 have one guide bar 7, 10, respectively, which can be fixed moveably in the ruler 4 and in the respectively desired position. Furthermore, each try square 5, 6 has a contact bar 8, which is oriented relative to the guide bar 7 at right angles and against which the tile to be cut is supposed to be placed with an edge, which is not to rest against the ruler 4. To enable also angular cuts, the ruler 4 is arranged on a swivel head 9.

In contrast to FIG. 1, FIG. 2 is an enlarged view of the swivel head 9 with the ruler 4. This ruler 4 has a straight guide 11, in which the guide bar 10 can be recognized. Both on the ruler 4 and on the guide bar 10 one sees a measuring scale 12, 13, with which it is possible to set a desired dimension for the cut of the tile. Furthermore, FIG. 2 shows a swivel head axis 14, about which the swivel head 9 with the ruler 4 can be swiveled by a defined amount. The ruler 4 has a contact edge 15, which runs through the swivel head axis 14.

In the swivel head 9 there are indexing notches 16 in the form of boreholes, all of which are located on a common pitch circle and into which a spring loaded drop-in ball (not illustrated) can drop in from the bottom. Thus, predetermined angular positions of the swivel head 9 can be fixed in advance so that during adjustment they do not have to be carefully checked. A curved member 17 with an angle scale 18 runs along the periphery of the swivel head 9 forming a semi-circular segment. Thus, it is possible to read the respective angular amount when one swivels the swivel head 9.

FIG. 3 is a sectional view of a sub-area of the supporting plate 1, with the swivel head 9, which is recessed therein and which can be rotated about the swivel axis 14, and with the curved member 17. The curved member 17 and the swivel head 9 exhibit a graduation 19, 20, both of which face each other and on which a clamping head 21 of a clamping bolt 22 is mounted. The latter has on the bottom side of the supporting plate 1 a head 23. Between this head 23 and the supporting plate 1 there is a clamping fork 24. FIG. 3 shows two prongs of this clamping fork 24, the prongs being designed in the shape of a wedge. The clamping fork 24 forms, together with the clamping bolt 22, the clamping head 21 and the head 23, a clamping device 25.

FIG. 4 depicts an adjusting lever 26, which is to be fastened to the bottom side of the supporting plate 1 by means of a bearing block 27. If the adjusting lever 26 is swiveled relative to the bearing block 27, then a rod 28 moves the clamping fork 24 and tightens or loosens the swivel head 9 in that the clamping head 21 sits on the graduation 20 or releases it, a procedure that can be seen in FIG. 3.

FIG. 5 shows the ruler 4 with the straight guide 11, in which the guide bar 10 can slide. From the guide bar 10 the try square 6 moves over the top side of the rule. To this end it is offset. Furthermore, FIG. 5 shows the arrangement of the measuring scales 12, 13.

### List of Reference Numerals

1 supporting plate

2 tool guide

3 hand lever

4 ruler

5 try square

6 try square

7 guide bar

8 contact bar

9 swivel head

10 guide bar

11 straight guide

12 measuring scale

13 measuring scale

14 swivel head axis

15 contact edge

16 indexing notch

17 curved member

18 angle scale

19 graduation

20 graduation

21 clamping head

22 clamping bolt

23 head

24 clamping fork

25 clamping device

26 adjusting lever

27 bearing block

28 rod

1. Tile cutting machine comprising a supporting plate (1) for a tile to be cut, comprising a tool guide (2), running over the supporting plate (1), for a cutting tool and comprising a swivel head (9), which can be moved by defined angular amounts about a swivel head axis (14) and which holds a try square (5, 6), which is provided with a measuring scale (13) and which can be slid lockingly in a straight guide (11) of the swivel head (9) with a guide bar (7, 10) and which exhibits a contact bar (8), which extends at right angles to the guide bar (7, 10) and for which additionally the swivel head (9) exhibits a ruler (4) with a contact edge, which runs through the swivel head axis (14), characterized by a total of two laterally reversed try squares (5, 6) for insertion into the straight guide (11) starting from the side opposite the swivel head axis (14).

2. Tile cutting machine, as claimed in claim 1, characterized in that the ruler (4) projects beyond the swivel head (9) in the direction of the sides, oriented in opposite directions, and forms a first contact edge (15) and exhibits a continuous straight guide (11), into which the guide bar (7, 10) of the respective try square (5, 6) can be installed.

3. Tile cutting machine, as claimed in claim 2, characterized in that on both sides of the swivel axis (14) the ruler (4) has a measuring scale (12) that begins with zero starting from the swivel head axis (14); and each guide bar (10, 7) exhibits a measuring scale (13) that begins with zero when its respective contact edge is above the swivel head axis (14).

4. Tile cutting machine, as claimed in at least one of the preceding claims, characterized in that the swivel head (9) forms a semi-circular segment and exhibits indexing notches (16) on a fixed pitch circle with uniform angular spacing and that the supporting plate (1) exhibits a spring-loaded ball detent for dropping a ball into the individual indexing notches (16).

5. Tile cutting machine, as claimed in at least one of the preceding claims, characterized in that on the outside along the periphery of the swivel head (9) a curved member (17), provided with an angle scale (18), is recessed, so as not to rotate, into the supporting plate (1), said curved member exhibiting a graduation (19) in the direction of the swivel head (9); that the swivel head (9) has correspondingly a graduation (20), oriented in the direction of the curved member (17); and that a clamping head (21) of a clamping bolt (22) sits on the two graduations (19, 20), said clamping head aligning with the upper side of the swivel head (9) and the curved member (17), and said clamping bolt, penetrating the supporting plate (1), is designed so as to move into a clamping position by means of a clamping device (25).

6. Tile cutting machine, as claimed in claim 5, characterized in that the clamping bolt (22) has a head (23) on the rear side of the supporting plate (1) and that the clamping device (25) exhibits a clamping fork (24), which is to be slid into its clamping position between the head (23) of the clamping bolt (22) and the supporting plate (1) by means of an adjusting lever (26).
